(19) United States
(12) Patent Application Publication
(10) Pub. No.: US 2007/0020558 A1
(43) Pub. Date: Jan. 25, 2007

(54) Process for the preparation of a photoresist solution

(76) Inventors: Wolfgang Zahn, Eltville (DE); Ralf Grottenmueller, Wiesbaden (DE); Carina Brauch-Fischer, Untershausen (DE); Andreas Dresel, Huenstetten (DE); Stefan Englert, Frankfurt (DE); Daniela Blaha, Bad Kreuznach (DE)

Correspondence Address: FROMMER LAWRENCE & HAUG, 745 FIFTH AVENUE- 10TH FL., NEW YORK, NY, 10151, US

(21) Appl. No.: 11/316,056

(22) Filed: Dec. 21, 2005

(30) Foreign Application Priority Data
Dec. 23, 2004 (DE) 10 2004 063 416.5

(51) Int. Cl. G03C 1/00

(52) U.S. Cl. 430/270.1; 430/311

(57) ABSTRACT

The invention relates to a process for the preparation of a photosensitive photoresist solution, characterized in that a novolak resin and a diazonaphthoquinonesulphonyl chloride are dissolved in a solvent from the group consisting of the photoresist solvents, a proportion of from 1 to 70 mol % of the phenolic hydroxyl groups of the novolak resin is reacted with diazonaphthoquinonesulphonyl chloride in the presence of a base, and the reaction mixture is washed with water and optionally diluted with further photoresist solvent.

The invention relates to a process for the preparation of a photosensitive photoresist solution, which process manages without isolation of intermediates. The photoresist is prepared by reacting a novolak and a diazo functional component directly in the solvent contained in the final resist formulation with subsequent purification but without precipitation and isolation of intermediates.

Photoresists are used in lithographic processes, for example for the production of microelectronic components, such as integrated circuits and computer chips. The generally known process for the production of integrated circuits consists, for example, in coating a silicon wafer with a thin layer of a photosensitive photoresist. The coated wafer is then baked in order to evaporate the solvent contained in the photoresist and to fix the resist layer on the substrate. The coated substrate is then irradiated through a photomask which produces a change in the chemical and physical characteristics of the resist layer. The radiation used is light in the infrared range, visible light, UV light, X-ray or electron beams. After the irradiation, the coated substrate is treated with a developer solution. In the case of a positive resist, the parts of the resist layer which have been exposed to the radiation are dissolved and removed. If the resist is a negative resist, the parts of the resist layer which have not been irradiated are dissolved and removed and the radiated parts remain behind. In the case of positive resists, the increase in the solubility on exposure to light is often achieved by rearrangement reactions or by elimination of protective groups. In the case of negative resists, the decrease in the solubility on exposure to light can be achieved, for example, by the occurrence of crosslinking reactions. In the parts where the resist layer was removed by the development process, the unprotected surface of the substrate is bared, which surface is then etched, for example with an etching solution or by means of a plasma treatment. The parts of the surface on which the resist layer is still present are not attacked by the etching process. The remaining resist layer is now completely removed from the substrate (stripping). A substrate surface on which an etch pattern is present which corresponds to the photomask used in the exposure to light remains behind.

Novolak resins are known as raw materials for positive-working photoresists which are particularly suitable for exposure at wavelengths of 365 nm (i-line), 405 nm (h-line) and 436 nm (g-line), which novolak resins are combined with diazonaphthoquinone functions. With these systems, it is possible to produce structures up to about 0.25 μm.

Thus, for example, JP 59084239 (Fuji) describes a photosensitive composition, the substantial component of which is a novolak resin, some of the phenolic OH groups of which are esterified with diazonaphthoquinone groups. The synthesis of the modified novolak takes place in the usual manner by reaction of the resin with a diazonaphthoquinone sulphonic acid chloride in an organic solvent mixture (methyl ethyl ketone/DMF) with triethylamine as an auxiliary base and subsequent precipitation of the product with water, recrystallization and drying.

JP-63 178229 (Fuji Photo Film) describes a positive photoresist formulation which is composed of a mixture of an alkali-soluble novolak resin and a hexahydroxybenzophenone esterified to an extent of over 90% with 1,2-naphthoquinone-4 or -5-sulphonic acid.

JP-10 097 066 (Shin-Etsu) discloses a positive-working photoresist consisting of a diazonaphthoquinone-modified novolak and a low molecular weight component. The modified novolak is prepared by esterification of 2.5-27 mol % of the OH groups of a novolak having a molecular weight of 2000-20 000 g/mol with 1,2-diazonaphthoquinonesulphonic acid groups. The low molecular weight component contains from 2 to 20 benzene units having a ratio of phenolic OH groups to benzene units of 0.5-2.5.

JP-11 228 528 describes the preparation of a diazonaphthoquinonesulphonic ester by esterification of a polyhydroxy compound with diazonaphthoquinone-4- or diazonaphthoquinone-5-sulphonic acid chloride in the presence of a base (e.g. triethylamine) in a solvent which has both ester and ether groups (e.g. ethyl ethoxypropionate). A good conversion, low toxicity, few secondary reactions and easy isolation of the product are mentioned as an advantage of such solvents. EP 1153915 (Toyo Gosei) describes an esterification of polyhydroxyphenol compounds (e.g. tetrahydroxybenzophenone) with 1,2-diazonaphthoquinonesulphonic acid chloride in an organic solvent (e.g. tetrahydrofuran) in the presence of an auxiliary base (e.g. triethylamine). After addition of an amide solvent (e.g. N,N-dimethylacetamide), the precipitated ammonium hydrochloride is filtered off and the product is precipitated in an excess of water and then dried.

U.S. Pat. No. 5,723,254 (Shipley) and U.S. Pat. No. 5,529,880 (Shipley) describe a positive-working photoresist formulation which consists of a mixture of different photoactive components. One of the components is an esterification product of diazonaphthoquinonesulphonic acid chloride with a phenol resin. A further component is an esterification product of diazonaphthoquinonesulphonic acid chloride with a low molecular weight phenol derivative which has one to three aromatic groups and one to three OH groups. An esterification product of diazonaphthoquinonesulphonic acid chloride with a relatively high molecular weight polynuclear phenol may also be added as a third component.

According to the prior art at the time, photoresist solutions based on novolaks are prepared in a multistage process. The different constituents, such as, for example, novolak resin and photoactive component, are prepared separately, isolated as a solid, then purified and dried. Particularly the precipitation of the photoactive component, which generally takes place in a large excess of water, and the subsequent drying of the material are process steps which are time consuming and require a large volume. The separately worked-up individual components are then dissolved in suitable ratios together in a common solvent, and the photosensitive photoresist solution ready for use is thus prepared.

WO 99/15935 (Clariant) describes a photoresist composition which comprises an alkali-soluble polymer or resin which has phenolic OH groups or carboxyl groups which are reacted with a vinyl ether or a dialkyl carbonate and a catalyst. The reaction takes place in an aprotic solvent (e.g. 1-methoxy-2-propyl acetate). After addition of a photo acid generator, the reaction solution of the polymer which has thus been prepared can be used directly as a photoresist solution without isolation of the polymer or further purification.

U.S. Pat. No. 5,919,597 (IBM, Shipley) describes a process for the preparation of a photoresist without isolation of intermediates in a “one-pot process” in a photoresist solvent.

The two last-mentioned publications limit themselves expressly to so-called “chemically amplified” systems. In chemically amplified systems, phenolic OH groups of a resin or polymer, for example the OH groups of poly(hydroxystyrene), are blocked with acid-labile groups (e.g. acetals and tert-butoxycarbonyl esters) in order to reduce the alkali solubility. The polymer modified in this manner is itself not photoactive and must therefore be combined with a photoactive component which, on exposure to light, liberates a strong acid which initiates a chemical reaction which liberates the phenolic OH groups of the polymer. The polymer thus becomes alkali-soluble in the exposed parts and can be developed there.

It was the object of the invention to provide a simplified process for the preparation of photosensitive photoresist solutions based on a non-chemically-amplified novolak, without the performance characteristics being adversely affected.

The invention relates to a process for the preparation of a photosensitive photoresist solution, characterized in that a novolak resin and a diazonaphthoquinonesulphonyl chloride are dissolved in a solvent from the group consisting of the photoresist solvents, a proportion of from 1 to 70 mol % of the phenolic hydroxyl groups of the novolak resin is reacted with diazonaphthoquinonesulphonyl chloride in the presence of a base, and the reaction mixture is washed with water and optionally diluted with further photoresist solvent.

In contrast to the systems described in WO 99/15935 and U.S. Pat. No. 5,919,597, the present invention does not involve a chemically amplified system but directly linking of the photoactive groups with the novolak resin. The change in the alkali solubility takes place directly as a result of the photochemical reaction and the associated transformation of a diazo group into a carboxylic acid function.

The reaction of the novolak with the diazonaphthoquinonesulphonyl chloride takes place directly in the solvent used in the final resist formulation. Complicated working-up of the reaction product by precipitation, isolation and tedious drying is not required. Undesired byproducts formed in the reaction, such as, for example, ammonium hydrochloride, which is obtained by amine-catalysed condensation of the phenolic OH groups of the novolak with the diazonaphthoquinonesulphonic acid chloride, can be removed without problems by washing with water.

Suitable novolak resins are those having a molecular weight of at least 1200 g/mol, which are obtainable by generally known acid- or metal ion-catalysed condensation reactions from phenols and lower aldehydes or ketones. Suitable phenols are, for example, phenol, o-, m- or p-alkylphenols, such as cresols (1-, 2- or 3-methylphenol), xylenols (2,3-, 2,4-, 2,5-, 2,6-, 3,4-, 3,5- or 3,6-dimethylphenol), o-, m- or p-phenylphenol, dialkylphenols, trialkylphenols, mono-, di- or trialkoxyphenols, pyrocatechol (1,2-dihydroxybenzene), resorcinol (1,3-dihydroxybenzene), hydroquinone (1,4-dihydroxybenzene), pyrogallol (1,2,3-trihydroxybenzene), 1,2,4-trihydroxybenzene or phloroglucinol (1,3,5-trihydroxybenzene). These or other phenols can be used alone or as mixtures of two or more components.

For example, formaldehyde, paraformaldehyde, trioxane, acetaldehyde, benzaldehyde, furfural, propionaldehyde, acrolein, crotonaldehyde, cyclohexylaldehyde, acetone, methyl ethyl ketone, diethyl ketone and diphenyl ketone are suitable as an aldehyde or ketone, which can be used individually or in combination.

A novolak resin suitably chosen on the basis of chemical and physical properties is modified, according to the invention, by reacting a proportion of from 1 to 70 mol %, preferably from 1.5 to 35 mol %, in particular from 2 to 25 mol %, of the phenolic hydroxyl group with a diazonaphthoquinonesulphonyl chloride, preferably with 2,1-diazonaphthoquinone-4-sulphonic acid chloride, 2,1-diazonaphthoquinone-5-sulphonic acid chloride, 1,2-diazonaphthoquinone-6-sulphonic acid chloride, 1,2-diazonaphthoquinone-7-sulphonic acid chloride, 1,2-diazonaphthoquinone-8-sulphonic acid chloride, 7-methoxy-2,1-diazonaphthoquinone-5-sulphonic acid chloride or 7-methoxy-2,1-diazonaphthoquinone-4-sulphonic acid chloride. The synthesis routes of these compounds are sufficiently well known and described (cf. for example: U.S. Pat. No. 6,274,714 (Toyo Gosei) and J. Bendig, E. Sauer, K. Polz, G. Schopf, “Synthesis and photochemistry of 1,2-naphthoquinonediazide-(2)-n-sulfonic acid derivatives”, Tetrahedron, 48 (42), 1992, pages 9207-9216).

The reaction of the novolak with the diazonaphthoquinonesulphonic acid chloride takes place in a solvent which is also retained in the final photoresist formulation. Photoresist solvents are, for example, PGME (1,2-propylene glycol monomethyl ether), PGMEA (1-methoxy-2-propyl acetate), ethyl lactate (lactic acid ethyl ester), butoxy (3-methoxybutyl acetate), PnB (1-butoxy-2-propyl acetate), ethyl acetate, butyl acetate, MEK (2-butanone), 2- or 3-pentanone, MIPK (3-methyl-2-butanone), MIBK (4-methyl-2-pentanone), MAK (2-heptanone), methylcellosolve (2-methoxyethanol), ethylcellosolve (2-ethoxyethanol), methylcellosolve acetate (2-methoxyethyl acetate), ethylcellosolve acetate (2-ethoxyethyl acetate), γ-butyrolactone, THF (tetrahydrofuran), tetrahydropyran, dioxane and cyclohexanone or a combination thereof.

Preferred as photoresist solvents are PGMEA (1-methoxy-2-propyl acetate), butoxy (3-methoxybutyl acetate), PnB (1-butoxy-2-propyl acetate), ethyl acetate, butyl acetate, MEK (2-butanone), 2- or 3-pentanone, MIPK (3-methyl-2-butanone), MIBK (4-methyl-2-pentanone), MAK (2-heptanone) and cyclohexanone or a combination thereof.

Particularly preferred solvents are PGMEA (1-methoxy-2-propyl acetate), butoxy (3-methoxybutyl acetate), PnB (1-butoxy-2-propyl acetate), butyl acetate, MAK (2-heptanone) or a combination thereof.

The reaction of the phenolic OH groups of the novolak with the sulphonic acid chloride requires the presence of a base in order to trap HCl liberated. Tertiary amines, such as, for example, triethylamine, pyridine, N-alkylmorpholine or triethanolamine, are preferred. However, other basic components are in principle also possible, including, for example, aqueous ammonia, inorganic hydroxides or carbonates or solid bases insoluble in the solvent used, such as, for example, basic ion exchangers.

The reaction according to the invention is preferably carried out at temperatures between −10° C. and +60° C., preferably at +10° C. to +40° C. Owing to the thermal instability of the diazo groups, higher temperatures are unsuitable.

The amount of the diazonaphthoquinonesulphonic acid chloride is such that the conversion, according to the invention, of the hydroxyl groups of the novolak is reached.

The amount of base is expediently to be chosen to be at least the molar equivalent of the sulphonic acid chloride. In order to accelerate the reaction and/or to ensure complete conversion, the base may also be used in excess.

The amount of the photoresist solvent is chosen so that the reaction solution can be easily handled and remains stirrable, i.e. the viscosity of the reaction solution does not become too high and all starting materials are completely dissolved. A solvent content of the reaction mixture of from 55 to 90% by weight is preferably employed.

Where a tertiary amine was used as the base, ammonium hydrochloride formed is removed after complete reaction of the reaction components. This can be effected by filtering off from precipitated salt or by washing with water. The salt dissolves virtually completely in the aqueous phase and can be removed by phase separation. If required, the washing with water can be repeated. Alternatively, a treatment with ion exchangers can also be carried out for removing ionic impurities.

In general, the photoresist solvent has a certain solubility for water, so that, after the washing, a certain amount of water remains homogeneously dissolved in the organic phase. If the amount of dissolved water is too high for the final application, the water can be removed without problems by distillation. Distillation is preferably effected under reduced pressure in order to keep the thermal load of the reaction solution as small as possible. The distillation can be effected batchwise from a flask or vessel or continuously with the aid of a thin-film evaporator. If the concentration of the resist solution obtained does not meet the requirements, either dilution can be effected with the same or a different photoresist solvent or concentration can be effected by distillation, membrane filtration or other suitable measures.

If required, further components may be added to the solution reacted according to the invention, in order, for example, to modify the photosensitivity, the dark decay, the absorption, the coating properties, the resolution or other properties of the resist solution. Possible further components are, for example, low molecular weight polynuclear phenol derivatives, such as, for example, polyhydroxybenzophenones or novolak oligomers having 2 to 5 aromatic units, the phenolic OH groups of which are free or have likewise been reacted with a diazo functional compound. Suitable polyhydroxybenzophenones are, for example, 4,4′-dihydroxy-benzophenone, 2,4-dihydroxybenzophenone, 2,4,4′-trihydroxybenzophenone and 2,3,4,4′-tetrahydroxybenzophenone, and suitable novolak oligomers are, for example, 4,4′-ethylenebisphenol, 2,2′-methylenebis[4-methylphenol], 4,4′,4″-methylidenetrisphenol, 2,6-bis[(2-hydroxy-5-methylphenyl)methyl]-4-methylphenol, 2,2′-[(4-hydroxyphenyl)methylene]bis(3,5-dimethylphenol), 2,2′-methylenebis[6-[(2-hydroxy-5-methylphenyl)methyl]-4-methylphenol] and 4,4′-[1-[4-[1-(4-hydroxy-3,5-dimethylphenyl)-1-methylethyl]phenyl]ethylidene]bis(2,6-dimethylphenol).

Moreover, the addition of further novolaks is possible.

The photoresist solution thus produced is applied onto substrates for manufacturing of semiconductor integrated circuit elements, color filters, and FPD such as liquid crystal display elements. The substrates can be any substrates having any size, such as glass substrates and silicon substrates. The substrates may be those containing a film such as a chromium film, a silicon oxide film, or an anti reflective film thereon. The substrates may be coated with the photosensitive resin composition by any known conventional method such as spin coating, roll coating, land coating, flowing and spreading coating, doctor coating, dip coating and slit coating. The photoresist solution is applied onto the substrate and then pre-baked to form a photoresist film. Then, the photoresist film is exposed to light through a photomask and developed by a method conventionally known or well-known in the art to form a resist pattern. Light with a wave length of 365 nm, 405 nm and 436 nm is preferred for this.

The developing agent applied in subsequent development may be any developing agent applied in conventional photosensitive resin compositions. Preferred examples of the developing agent include alkali developing agents, that is, aqueous solutions of alkaline compounds such as tetraalkylammoniumhydroxide, choline, alkalimetalhydroxides, alkali metal metasilicates (hydrate), alkali metal phosphates (hydrate), ammonia water, alkylamines, alkanolamines and heterocyclic amines; an aqueous solution of tetramethylammonium hydroxide is particularly preferred as alkali developing solution. If necessary, these alkali developing solutions may contain water-soluble organic solvents such as methanol and ethanol or surfactants. After development with the alkali developing solution, water washing is usually carried out.

A further object of the invention is a process for the structured coating of a substrate, where
a) a novolak resin and a diazonaphtoquinonesulphonyl chloride are dissolved in a solvent from the group consisting of the photoresist solvents, a proportion of from 1 to 70 mol % of the phenolic hydroxyl groups of the novolak resin is reacted with diazonaphthoquinonesulphonyl chloride in the presence of a base, and the reaction mixture is washed with water and optionally diluted with further photoresist solvent, and the photoresist solution thus obtained, is directly
b) coated unto a substrate and pre-baked,
c) the photoresist film formed is irradiated through a photomask,
d) the irradiated photoresist film is baked and
e) the baked, irradiated photoresist film is developed with an alkali developer.

The synthesis is illustrated below from several examples, without being limited thereby; examples 1 to 3 being carried out by the process according to the invention, and comparative examples 1 to 3 by the conventional process with isolation of the intermediates.

### EXAMPLE 1

900 g of a novolak (40:60 m-cresol/p-cresol, average molecular weight 4000 g/mol, measured by GPC against a polystyrene standard) and 60.8 g of 2,1-diazonaphthoquinone-5-sulphonic acid chloride are dissolved in 3750 g of PGMEA to give a clear solution. 40 g of triethanolamine are added at a temperature of 20° C. and stirring is effected for 60 min. The solution is now washed with 1700 g of 0.3% strength by weight aqueous HCl. After the aqueous phase has been separated off, the PGMEA phase is washed with 1700 g of demineralized water and the aqueous phase is separated off. The organic phase is initially distilled at 45° C. and a vacuum of 20 mbar for 60 min. A mixture of water and PGMEA distils off. The vacuum is then changed to a pressure of 8 mbar and distillation is effected for about a further 60 min, virtually pure PGMEA being distilled off. 2714 g of a 35% strength by weight solution of the diazonaphthoquinone-functionalized novolak in PGMEA, having a water content of <0.2% and a chloride ion content of <20 ppm, remain. The average degree of esterification is 3 mol %, i.e. on average 3 monomer units out of 100 phenolic monomer units of the novolak are esterified.

### EXAMPLE 2

900 g of a novolak (40:60 m-cresol/p-cresol, average molecular weight 4000 g/mol, measured by GPC against a polystyrene standard) and 101.3 g of 2,1-diazonaphthoquinone-5-sulphonic acid chloride are dissolved in 3750 g of PGMEA to give a clear solution. 67 g of triethanolamine are added at a temperature of 20° C. and stirring is effected for 60 min. The solution is now washed with 1700 g of 0.4% strength by weight aqueous HCl. After the aqueous phase has been separated off, the PGMEA phase is washed with 1700 g of demineralized water and the aqueous phase is separated off. The organic phase is initially distilled at 45° C. and a vacuum of 20 mbar for 60 min. A mixture of water and PGMEA distils off. The vacuum is then changed to a pressure of 8 mbar and distillation is effected for about a further 60 min, virtually pure PGMEA being distilled off. 2800 g of a 35% strength by weight solution of the diazonaphthoquinone-functionalized novolak in PGMEA, having a water content of <0.2% and a chloride ion content of <20 ppm, remain. The mean degree of esterification is 5 mol %.

### EXAMPLE 3

900 g of a novolak (m-cresol/2,5-xylenol, average molecular weight 2500 g/mol, measured by GPC against a polystyrene standard) and 200.1 g of 2,1-diazonaphthoquinone-5-sulphonic acid chloride are dissolved in 3750 g of PGMEA to give a clear solution. 131.5 g of triethanolamine are added at a temperature of 20° C. and stirring is effected for 60 min. The solution is now washed with 1700 g of 0.8% strength by weight aqueous HCl. After the aqueous phase has been separated off, the PGMEA phase is washed with 1700 g of demineralized water and the aqueous phase is separated off. The organic phase is initially distilled at 45° C. and a vacuum of 20 mbar for 60 min. A mixture of water and PGMEA distils off. The vacuum is then changed to a pressure of 8 mbar and distillation is effected for about a further 60 min, virtually pure PGMEA being distilled off. 2995 g of a 35% strength by weight solution of the diazonaphthoquinone-functionalized novolak in PGMEA, having a water content of <0.2% and a chloride ion content of <20 ppm, remain. The mean degree of esterification is 10 mol %.

### Comparative Example 1

(Same Components as in Example 1, but with Isolation of the Intermediate)

900 g of a novolak (40:60 m-cresol/p-cresol, average molecular weight 4000 g/mol, measured by GPC against a polystyrene standard) and 60.8 g of 2,1-diazonaphthoquinone-5-sulphonic acid chloride are dissolved in 3000 g of acetone to give a clear solution. At a temperature of from 15 to 20° C., 25 g of triethylamine are added dropwise in the course of 30 min and stirring is carried out for a further 60 min. The solution is filtered off from precipitated ammonium hydrochloride and is slowly added dropwise to 20 kg of 0.1% strength by weight aqueous HCl. The precipitated product is filtered off with suction, washed with 2 kg of demineralized water, dissolved in 2500 g of acetone and precipitated again by dropwise addition to 10 kg of demineralized water. After washing with 2 kg of demineralized water, the product is sucked dry and is dried at 40° C. for 72 h. 880 g of a red-brown solid having a water content of <0.2% and a chloride ion content of <20 ppm are obtained. The mean degree of esterification is 3 mol %. For further processing, 350 g of the product are dissolved in 650 g of PGMEA to give a 35% strength by weight formulation in the form of a clear solution.

### Comparative Example 2

(Same Components as in Example 2, but with Isolation of the Intermediate)

900 g of a novolak (40:60 m-cresol/p-cresol, average molecular weight 4000 g/mol, measured by GPC against a polystyrene standard) and 101.3 g of 2,1-diazonaphthoquinone-5-sulphonic acid chloride are dissolved in 3000 g of acetone to give a clear solution. At a temperature of from 15 to 20° C., 42 g of triethylamine are added dropwise in the course of 30 min and stirring is carried out for a further 60 min. The solution is filtered off from precipitated ammonium hydrochloride and is slowly added dropwise to 20 kg of 0.12% strength by weight aqueous HCl. The precipitated product is filtered off with suction, washed with 2 kg of demineralized water, dissolved in 2500 g of acetone and precipitated again by dropwise addition to 10 kg of demineralized water. After washing with 2 kg of demineralized water, the product is sucked dry and is dried at 40° C. for 72 h. 932 g of a red-brown solid having a water content of <0.2% and a chloride ion content of <20 ppm are obtained. The mean degree of esterification is 5 mol %. For further processing, 350 g of the product are dissolved in 650 g of PGMEA to give a 35% strength by weight formulation in the form of a clear solution.

### Comparative Example 3

(Same Components as in Example 3, but with Isolation of the Intermediate)

900 g of a novolak (m-cresol/2,5-xylenol, average molecular weight 2500 g/mol, measured by GPC against a polystyrene standard) and 200.1 g of 2,1-diazonaphthoquinone-5-sulphonic acid chloride are dissolved in 3000 g of acetone to give a clear solution. At a temperature of from 15 to 20° C., 82.5 g of triethylamine are added dropwise in the course of 30 min and stirring is carried out for a further 60 min. The solution is filtered off from precipitated ammonium hydrochloride and is slowly added dropwise to 20 kg of 0.14% strength by weight aqueous HCl. The precipitated product is filtered off with suction, washed with 2 kg of demineralized water, dissolved in 2500 g of acetone and precipitated again by dropwise addition to 10 kg of demineralized water. After washing with 2 kg of demineralized water, the product is sucked dry and is dried at 40° C. for 72 h. 985 g of a red-brown solid having a water content of <0.2% and a chloride ion content of <20 ppm are obtained. The mean degree of esterification is 10 mol %. For further processing, 350 g of the product are dissolved in 650 g of PGMEA to give a 35% strength by weight formulation in the form of a clear solution.

The solutions prepared in examples 1 to 3 and comparative examples 1 to 3 are diluted with PGMEA to a solids content of 27% by weight altogether, and further additives stated in the table below are optionally added, ready-to-use resist solutions forming.

| | Product from:¹⁾ | | | | | |
|---|---|---|---|---|---|---|
| | Ex- | Comparative | | | | |
| Resist | ample | example | PAC²⁾ | PGMEA | Additive³⁾ | SC⁴⁾ |
| No. 1 | 1 | — | 3 g | 33 g | 0.015 g | 27% |
| No. 2 | — | 1 | 3 g | 33 g | 0.015 g | 27% |
| No. 3 | 2 | — | — | 25 g | 0.015 g | 27% |
| No. 4 | — | 2 | — | 25 g | 0.015 g | 27% |
| No. 5 | 3 | — | — | 25 g | 0.015 g | 27% |
| No. 6 | — | 3 | — | 25 g | 0.015 g | 27% |

¹⁾In each case 86 g of the 35% strength solution
²⁾2,3,4-Trishydroxybenzophenone esterified to an extent of 85 mol % with 2,1-diazonaphthoquinone-5-sulphonic acid chloride
³⁾KP 341: Wetting agent
⁴⁾Solids content of the formulation in percent by weight

In lithographic tests, no differences in properties are recognizable between the products synthesized directly in solution and the products isolated as solid and subsequently dissolved.

The lithography process is carried out as follows:

The Si wafer is coated with the solution by spin coating, the speed being adjusted so that a target layer thickness of 1.2 μm after drying of the layer is achieved. After the coating, the wafer is baked on a controllable hotplate under defined conditions to remove the solvent. In general, drying is effected at a temperature of 90° C. for 60 s. The layer is then exposed to different doses of light using a stepper, the exposure being tailored so that there are underexposures and overexposures, i.e. masked structures are imaged with dimensions which are greater than the nominal dimension to dimensions which are smaller than the nominal dimension. After the exposure time, the wafer is baked on the hotplate at 110° C. for 60 s. Thereafter, the layer is developed with an aqueous, 2.38% strength by weight tetramethylammonium hydroxide solution for 60 s at 23° C. and the wafer is then rinsed with demineralized water. During the development, the previously exposed parts are dissolved away.

The results are summarized in the table below:

| Resist | DTP [mJ/cm²]¹⁾ | Dark decay [nm/min] |
|---|---|---|
| No. 1 | 39 | 49 |
| No. 2 | 33 | 73 |
| No. 3 | 63 | 7 |
| No. 4 | 65 | 9 |
| No. 5 | 29 | 46 |
| No. 6 | 31 | 54 |

¹⁾Dose to print

As low a DTP value as possible is strived for, which means high photosensitivity so that only a low exposure energy is required, and as low a dark decay as possible. The dark decay indicates the layer thickness removed during the development in the unexposed parts.

It is found that photoresists prepared by the process according to the invention have good lithographic properties comparable with those of photoresists prepared by a conventional method.

1. Process for the preparation of a photosensitive photoresist solution, where a novolak resin and a diazonaphthoquinonesulphonyl chloride are dissolved in a solvent from the group consisting of the photoresist solvents, a proportion of from 1 to 70 mol % of the phenolic hydroxyl groups of the novolak resin is reacted with diazonaphthoquinonesulphonyl chloride in the presence of a base, and the reaction mixture is washed with water and optionally diluted with further photoresist solvent.

2. Process according to claim 1, where the novolak resin has a molecular weight of at least 1200 g/mol.

3. Process according to claim 1, where a proportion of from 1.5 to 35 mol % of the phenolic hydroxyl group of the novolak resin is reacted with the diazonaphthoquinonesulphonyl chloride.

4. Process according to claim 1, where a proportion of from 2 to 25 mol % of the phenolic hydroxyl group of the novolak resin is reacted with the diazonaphthoquinonesulphonyl chloride.

5. Process according to claim 1, where the diazonaphthoquinonesulphonyl chloride is 2,1-diazonaphthoquinone-4-sulphonic acid chloride, 2,1-diazonaphthoquinone-5-sulphonic acid chloride, 1,2-diazonaphthoquinone-6-sulphonic acid chloride, 1,2-diazonaphthoquinone-7-sulphonic acid chloride, 1,2-diazonaphthoquinone-8-sulphonic acid chloride, 7-methoxy-2,1-diazonaphthoquinone-5-sulphonic acid chloride or 7-methoxy-2,1-diazonaphthoquinone-4-sulphonic acid chloride.

6. Process according to claim 1, where the photoresist solvent is 1,2-propylene glycol monomethyl ether, 1-methoxy-2-propyl acetate, ethyl lactate, 3-methoxybutyl acetate, 1-butoxy-2-propyl acetate, ethyl acetate, butyl acetate, 2-butanone, 2- or 3-pentanone, 3-methyl-2-butanone, 4-methyl-2-pentanone, 2-heptanone, methylcellosolve, ethylcellosolve, methylcellosolve acetate, ethylcellosolve acetate, y-butyrolactone, tetrahydrofuran, tetrahydropyran, dioxane and cyclohexanone or a combination thereof.

7. Process according to claim 6, where the photoresist solvent is 1-methoxy-2-propyl acetate, 3-methoxybutyl acetate, 1-butoxy-2-propyl acetate, ethyl acetate, butyl acetate, 2- or 3-pentanone, 3-methyl-2-butanone, 4-methyl-2-pentanone, 2-heptanone and cyclohexanone or a combination thereof.

8. Process according to claim 7, where the photoresist solvent is 1-methoxy-2-propyl acetate, 3-methoxybutyl acetate, 1-butoxy-2-propyl acetate, butyl acetate and 2-heptanone or a combination thereof.

9. Process according to claim 1, where the base is a tertiary amine, an inorganic hydroxide or carbonate or a basic ion exchanger.

10. Process according to claim 1, where the reaction is carried out at a temperature between −10° C. and +60° C.

11. Process according to claim 1, where the solvent content is from 55 to 90% by weight, based on the total weight of the solution.

12. Process according to claim 1, where polyhydroxybenzophenones, the OH groups of which are free or have been esterified with diazonaphthoquinone groups, are added to the reacted solution.

13. Process according to claim 1, where novolak oligomers having 2 to 5 aromatic units, the phenolic OH groups of which are free or have been esterified with diazonaphthoquinone groups, are added to the reacted solution.

14. Process according to claim 1, where a novolak resin is added to the reacted solution.

15. Process for the structured coating of a substrate, where
a) a novolak resin and a diazonaphthoquinonesulphonyl chloride are dissolved in a solvent from the group consisting of the photoresist solvents, a proportion of from 1 to 70 mol % of the phenolic hydroxyl groups of the novolak resin is reacted with diazonaphthopquinonesulphonyl chloride in the presence of a base, and the reaction mixture is washed with water and optionally diluted with further photoresist solvent, and the photoresist solution thus obtained is directly
b) coated unto a substrate and pre-baked,
c) the photoresist film formed is irradiated through a photomask,
d) the irradiated photoresist film is baked and
e) the baked, irradiated photoresist film is developed with an alkali developer.
